(19) United States
(12) Patent Application Publication
(10) Pub. No.: US 2005/0264450 A1
(43) Pub. Date: Dec. 1, 2005

(54) MICROSTRIP LINE TYPE PLANAR ARRAY ANTENNA

(76) Inventors: Eisuke Nishiyama, Saga (JP); Masayoshi Aikawa, Saga (JP); Fumio Asamura, Saitama (JP); Takeo Oita, Saitama (JP)

Correspondence Address: KATTEN MUCHIN ROSENMAN LLP, 575 MADISON AVENUE, NEW YORK, NY, 10022-2585, US

(21) Appl. No.: 11/046,550

(22) Filed: Jan. 28, 2005

(30) Foreign Application Priority Data
Jan. 28, 2004 (JP) 2004-020576
Jan. 27, 2005 (JP) 2005-020449

(51) Int. Cl. H01Q 1/38

(52) U.S. Cl. 343/700 MS; 343/846

(57) ABSTRACT

A planar array antenna comprises a powered antenna element and an adjacent passive element which are microstrip-line type ones and disposed on one principal surface of a dielectric substrate; and a feeding system for feeding high frequency power to the powered antenna element. The powered antenna element and a passive element disposed ahead of the powered antenna element constitute a powered element pair, and the adjacent passive element and a passive antenna element disposed ahead of the adjacent passive element constitute a passive element pair. The passive element pair is disposed so that it adjoins said powered element pair in an electric field direction or a magnetic field direction of radio wave emitted from the powered antenna element.

### BACKGROUND OF THE INVENTION

1. Technical Field of the Invention

The present invention relates to a planar array antenna having microstrip-line antenna elements, which is primarily applied in millimeter wave and microwave bands, and more particularly to a planar array antenna which has an improved high antenna gain and maintains a wide bandwidth.

2. Description of the Related Art

With the developments in radio communication technologies, especially mobile communications, antennas are required to be of higher performance and smaller size. Planar antennas are widely used in millimeter wave and microwave bands. Planar antennas are generally grouped into microstrip-line antennas and slot-line antennas. Of these planar antennas, microstrip-line planar antennas are small in size and can easily be manufactured, and has a feature that it can be produced at low cost and the like. However, since microstrip-line planar antennas have a relatively low antenna gain, it has been customary to construct a microstrip-line planar array antenna using a plurality of the antenna elements. The present inventors have already proposed in Japanese Patent Laid-open Application No. 2003-115717 (JP, P2003-115717A), a planar array antenna which can facilitate impedance mating in a feeding system for a plurality of antenna elements of microstrip-line type and remarkably simplify the constitution of the feeding system.

FIG. 1A is a plan view of a conventional microstrip-line planar array antenna in which the number of antenna elements which are fed is four, and FIG. 1B a cross-sectional view taken along line A-A of FIG. 1A.

On one principal surface of substrate 1 which is made of a dielectric material, antenna elements 2a to 2d each of which is constructed by a square conductor and a feeding system which supplies RF power to the antenna elements 2a to 2d. Each of antenna elements 2a to 2d is an antenna element of a microstrip-line type, and these antenna elements are arranged in a quadruplet manner. The centers of antenna elements 2a to 2d are disposed on the position of apexes of a geometric square, for example, apexes of a certain regular square. Ground conductor 4 is formed on an almost entire surface of the other principal surface of substrate 1. In the example shown here, the antenna elements are arranged in a matrix in two horizontal rows and two vertical columns.

The feeding system comprises microstrip line 3a which is formed, as a first feeding line, on one principal surface of substrate 1, slot line 3b which is formed, as a second feeding line, on the ground conductor in the other principal surface of substrate 1, and microstrip line 3c which is formed, as a third feeding line, on one principal surface of substrate 1.

Microstrip line (i.e., the first feeding line) 3a connects antenna elements disposed adjacent in the right and left direction. Among two microstrip lines 3a , both ends of upper microstrip line 3a are connected to antenna elements 2a, 2b, respectively. Similarly, both ends of lower microstrip line 3a are connected to antenna element 2c, 2d. Slot line (i.e., the second feeding line) 3b both ends which traverse two microstrip lines 3a at the proximity of midpoints of these microstrip lines 3a and are electromagnetically coupled to microstrip lines 3a. Microstrip line (i.e., the third feeding line) 3c extends from the feeding end T disposed at the left end of substrate 1, and the tip end of microstrip line 3c traverses the mid point of slot line 3b and is electromagnetically coupled to slot line 3b.

In this case, with the wavelength corresponding to antenna frequency (i.e., resonant frequency) taken as λ, the both ends of slot line 3b extend approximately λ/4 in length from the traversing points with upper and lower microstrip lines 3a and become electrically open ends for the resonant frequency component seen from the traversing points. Similarly, the tip end of microstrip line 3c extends approximately λ/4 in length from the traversing point with slot line 3b and becomes electrically an electrically short-circuited end for the resonant frequency component seen from the traversing point.

Explanations will be made for the case of transmission, for example. In such an array antenna, as electric field E illustrated by a arrow mark and a mark indicating the direction against the substrate plane, high frequency power P from feeding end T of microstrip line 3c is first propagated to slot line 3b and then it branches in-phase upper and lower directions on slot line 3b from the midpoint of slot line 3b. That is, the high frequency power branches in-phase from microstrip line 3c to slot line 3b. High frequency power P is then propagated to microstrip line 3a from the end portion of slot line 3b, and it branches in opposite phase in left and right directions on microstrip line 3a from the midpoint of microstrip line 3a. Each of antenna elements 2a to 2d is thus fed through microstrip line 3c, slot line 3b and microstrip line 3a. In the following description, an antenna element which is connected to an end of a feeding line of a microstrip line type to be fed with the high frequency power is referred to as a powered antenna element. Consequently, antenna elements 2a to 2d are powered antenna elements.

As obvious from the figure, since the feeding positions on powered antenna elements 2a, 2c, that is, the connecting positions of microstrip strip lines 3a have a mirror symmetric relation to the feeding positions on powered antenna elements 2b, 2d, each of antenna elements 2a to 2d is excited in-phase. Radio waves having the same polarization plane are emitted from respective antenna elements 2a to 2d in the perpendicular direction and these radio waves are combined. In this case, the electric field plane direction of the radio wave is in the feeding direction of the high frequency power and the magnetic field plane direction is perpendicular to the electric field plane direction. Of course, in the case of reception, this array antenna operates in the same manner as described above.

By comparing one in which the feeding system is arranged with only microstrip lines, this array antenna has a simple configuration for impedance matching and the feeding system of a simple structure. Further, with a configuration in which four antenna elements are arranged in the above manner taken as a basic unit, an array antenna having more number of the powered antenna elements can be configured by combining a plurality of the basic units.

For example, with the four-element array antenna described above taken as the basic unit, an eight-element array antenna can be constructed as shown in FIG. 2A by arranging two pieces of the basic units in mirror symmetry (or point symmetry) around feeding ends T of these basic units as a center, connecting microstrip lines 3c of the two basic units to each other, and electromagnetically coupling slot line 3d as a fourth feeding line to the midpoint of the common-connected microstrip line 3c.

Further, a 16-element array antenna is constructed as shown in FIG. 2B by preparing two pieces of the eight-element array antennas shown in FIG. 2A, arranging two pieces of the eight-element array antennas in mirror symmetry (or point symmetry) around the feeding ends thereof as a center, connecting slot lines 3d to each other, and electromagnetically coupling microstrip line 3e as a fifth feeding line to the midpoint of the common-connected slot line 3d. The 16-element array antenna shown in FIG. 2B is provided with four pieces of the basic units described above.

An array antenna having further number of antenna elements can be constructed by combining array antennas in the above manner. Specifically, n being integer larger than or equal to 3, an array antenna having 2ⁿ⁺¹ pieces of antenna elements is constructed by arranging two pieces of 2ⁿ-element array antennas in mirror symmetry or point symmetry around a feeding end of the (n+1)-th feeding line as a center, connecting the (n+1)-th feeding lines of the 2ⁿ-array antennas to each other, and providing an (n+2)-th feeding line which traverses a midpoint of the common-connected (n+1)-th feeding line and is electromagnetically coupled to the common-connected (n+1)-th feeding line. In this 2ⁿ⁺¹-element array antenna, 2ⁿ⁻¹-pieces of the basic units describe above are included. It should be noted that an m-th feeding line is a microstrip line when m is an odd number and the m-th feeding line is a slot line when m is an even number.

The planar array antenna described above has, however, an disadvantage that it basically has a narrow frequency band width because each powered antenna element is an antenna element of a microstrip line type. Therefore, it is proposed in Japanese Patent Laid-open Application No. 2004-328067 (JP, P2004-328067A) to widen the band width of frequency characteristics of the antenna by disposing a passive element ahead of the powered antenna element. FIGS. 3A to 3C illustrate a microstrip line planar array antenna whose frequency band is widen by loading a passive element to each powered antenna element. The passive element means an antenna element of a microstrip line type which consists of a conductor just like the powered antenna element but is not directly connected to a feeding line. The passive element is excited through the electromagnetic coupling with the powered antenna element and emits electromagnetic wave.

The array antenna shown in FIGS. 3A to 3C is one in which passive antenna elements 6a to 6d are loaded to the four-element array antenna shown in FIGS. 1A to 1C. FIG, 3A is a plan view illustrating an intermediate layer in the array antenna, FIG. 3B is a plan view of the array antenna, and FIG. 3C is a cross-sectional view taken along line A-A of FIG. 3A.

Powered antenna elements 2a to 2d are disposed on one principal surface of a first substrate which consists of a dielectric material, and ground conductor 4 is arranged on the other principal surface of the first substrate. Second substrate 1b which consists of a dielectric material is laminated on the one principal surface of first substrate 1a so that second substrate 1b covers antenna elements 2a to 2d. Multilayer substrate 5 is constituted from first substrate 1a and second substrate 1b. Antenna elements 2a to 2d are sandwiched and disposed between first and second substrates 1a, 1b, and the plane in which antenna elements 2a to 2d are formed is referred to as an intermediate layer. The arrangement of the feeding system for antenna elements 2a to 2d is identical to that shown in FIGS. 1A and 1B.

On the surface of second substrate 1b, passive elements 6a to 6d which are not connected to the feeding system are disposed at the position ahead of powered antenna elements 2a to 2d which are disposed on the intermediate layer so that passive elements 6a to 6d oppose to powered antenna elements 2a to 2d, respectively. It should be noted that a pair of a powered antenna element and a passive element corresponding to the powered antenna element is referred to as a powered element pair. Therefore, the antenna illustrated in the figure is provided with four sets of powered element pairs 26a to 26d. The frequency band of a microstrip line planar array antenna is widen by arranging a passive element ahead of each powered antenna element in this manner. However, in this configuration, as the number of the antenna elements is increased for improving the antenna gain, the number of the basic units described above is also increased and the feeding loss is increased. It is required to supply more high frequency power to the antenna.

### SUMMARY OF THE INVENTION

It is therefore an object of the present invention to provide a planar array antenna of a microstrip line type which can reduce the number of powered antenna elements and has an improved antenna gain.

The above object can be achieved by a planar array antenna comprising a substrate made of a dielectric material, a powered antenna element of a microstrip-line type disposed on one principal surface of the substrate, a ground conductor disposed on the other principal surface of the substrate, a feeding system for feeding high frequency power to the powered antenna element, an adjacent passive element disposed on the one principal surface of the substrate, a first passive element disposed ahead of the powered antenna element with space therebetween; and a second passive element disposed ahead of the adjacent passive element with space therebetween, wherein the powered antenna element and a first passive element corresponding to the powered antenna element constitute a powered element pair, the adjacent passive element and a second passive element corresponding to the adjacent passive element constitute a passive element pair, and the passive element pair is disposed so that it adjoins the powered element pair in an electric field direction or a magnetic field direction on electromagnetic wave emitted from the powered antenna element.

Since the powered element pair in which the powered antenna element and the first passive element oppose to each other via the dielectric substrate and the passive element pair in which the adjacent antenna element and the second first passive element oppose to each other via the dielectric substrate with the same condition adjoin to each other in the array antenna according to the present invention, the powered element pair and the passive element pair are easily electromagnetically coupled to each other. For example, the passive element pair easily receives the leak electromagnetic field from the powered element pair and both pairs are electromagnetically coupled to each other easily. Since the passive element pair is disposed in an electric field plane direction or a magnetic field direction of the electromagnetic wave emitted from the powered element pair, the powered element pair and the passive element pair electromagnetically couple to each other directly. As a result, the passive element also emits the electromagnetic wave with increased electromagnetic field intensity at the antenna frequency. Then the electromagnetic waves from the powered element pair and the passive element pair are combined and emitted. As a result, a planar array antenna having an antenna gain equivalent to that of a conventional array antenna in which all antenna elements are powered antenna elements is obtained. According to the present invention, it is possible to reduce the number of powered antenna elements to which high frequency power is supplied while improving the antenna gain.

In the present invention, it is preferable to construct a basic unit by two sets of the powered element pairs and a plurality sets of the passive element pairs. It is preferable to provide, in the basic unit, a first feeding line consisting of a microstrip-line which connects at both ends thereof to two powered antenna elements, and a second feeding line consisting of a slot line formed in said ground conductor, the second feeding line traversing a midpoint of the first feeding line and electromagnetically coupled to the first feeding line. In this case, the high frequency power from a feeding end of the second feeding line branches in opposite phase to opposing directions in the electric field from the midpoint of the first feeding line, and then is supplied to two powered antenna elements. As a result, the two powered antenna elements are excited in-phase and emits electromagnetic wave with the same polarization plane. Therefore, by utilizing the above basic units, impedance matching in the feeding system is facilitated and the structure of the feeding system is simplified.

According to the present invention, it is possible to easily construct an planar array antenna with numbers of elements by using a plurality pieces of the basic units described above and combining an opposite-phase branch to a microstrip line from a slot line and an in-phase branch to a slot lint from a microstrip line to configure the feeding system. In such a multi-element planar array antenna, it is possible to improve the antenna gain while suppress the increase in the number of the powered antenna elements.

### BRIEF DESCRIPTION OF THE DRAWINGS

FIG. 1A is a plan view illustrating a conventional four-element planar array antenna having microstrip-line antenna elements;

FIG. 1B is a cross-sectional view taken along line A-A of FIG. 1A;

FIG. 2A is a plan view illustrating a conventional eight-element planar array antenna;

FIG. 2B is a plan view illustrating a conventional 16-element planar array antenna;

FIG. 3A is a plan view illustrating an intermediate layer in a conventional microstrip-line planar array antenna;

FIG. 3B is a plan view of the planar array antenna shown in FIG. 3A;

FIG. 3C is a cross-sectional view taken along line A-A of FIG. 3B;

FIG. 4A is a plan view illustrating an intermediate layer of a basic unit which constitutes a planar array antenna according to a first embodiment of the present invention;

FIG. 4B is a plan view of the basic unit shown in FIG. 4A;

FIG. 4C is a cross-sectional view taken along line A-A of FIG. 4B;

FIG. 5 is a plan view illustrating an intermediate layer of another basic unit in the planar array antenna according to the first embodiment;

FIG. 6A is a plan view illustrating an intermediate layer in a planar array antenna with four powered antenna elements according to the first embodiment;

FIG. 6B is a plan view illustrating an intermediate layer in a planar array antenna with eight powered antenna elements according to the first embodiment;

FIG. 7A is a plan view illustrating an intermediate layer in another planar array antenna with four powered antenna elements according to the first embodiment;

FIG. 7B is a plan view illustrating an intermediate layer in another planar array antenna with eight powered antenna elements according to the first embodiment;

FIG. 8A is a plan view illustrating an intermediate layer of a basic unit which constitutes a planar array antenna according to a second embodiment of the present invention;

FIG. 8B is a plan view of the basic unit shown in FIG. 8A;

FIG. 8C is a cross-sectional view taken along line A-A of FIG. 8B;

FIG. 9A is a plan view illustrating an intermediate layer in a planar array antenna with four powered antenna elements according to the second embodiment;

FIG. 9B is a plan view illustrating an intermediate layer in a planar array antenna with eight powered antenna elements according to the second embodiment;

FIG. 10A is a plan view illustrating an intermediate layer of a basic unit which constitutes a planar array antenna according to a third embodiment of the present invention;

FIG. 10B is a plan view of the basic unit shown in FIG. 10A;

FIG. 10C is a cross-sectional view taken along line A-A of FIG. 10B;

FIG. 11A is a plan view illustrating an intermediate layer in a planar array antenna with four powered antenna elements according to the third embodiment;

FIG. 11B is a plan view illustrating an intermediate layer in a planar array antenna with eight powered antenna elements according to the third embodiment;

FIG. 12A is a plan view illustrating a second intermediate layer of another basic unit in a planar array antenna according to the third embodiment;

FIG. 12B is a plan view of the basic unit shown in FIG. 12A;

FIG. 12C is a cross-sectional view taken along line A-A of FIG. 12B;

FIG. 13A is a plan view illustrating an intermediate layer of a basic unit which constitutes a planar array antenna according to another embodiment of the present invention;

FIG. 13B is a plan view of the basic unit shown in FIG. 13A; and

FIG. 13C is a cross-sectional view taken along line A-A of FIG. 13B.

### DETAILED DESCRIPTION OF THE PREFERRED EMBODIMENTS:

The microstrip line type planar array antenna according to the present invention uses basic units each comprising two pieces of powered antenna elements and is configured that a plurality of the basic units are fed with high frequency power using a feeding system which consists of a microstrip line and a slot line. In the basic unit, the powered antenna elements are connected to both ends, respectively, of a microstrip line which is a first feeding line. A passive element (i.e., a first passive element) is disposed ahead of the powered antenna element to constitute the powered element pair described above. Further, the basic unit comprises a passive element (i.e., an adjacent passive element) disposed in a plane in which the powered antenna element is disposed, and a passive element (i.e., a second passive element) disposed ahead of the adjacent passive element. The adjacent passive element adjoins the powered antenna element. The pair consisting of the adjacent passive element and the passive element ahead of the adjacent passive element is referred to as a passive element pair. The adjacent passive element adjoins the powered antenna element in an electric field direction or a magnetic field direction of the electromagnetic wave emitted from the powered antenna element.

There are various types of the arrangement of the powered element pairs and the passive element pairs in a basic unit. For example, among four apexes of a regular square or rectangle, the powered element pairs may be disposed on two apexes sharing one side and the passive element pairs may be disposed on the two remaining apexes. Alternatively, among four apexes of a regular square or rectangle, the powered element pairs may be disposed on two apexes which share one diagonal and the passive element pairs may be disposed on the two remaining apexes. Further, among the lattice points arranged by 2×3 in an orthogonal grid, the powered element pairs may be disposed on two center lattice points and the passive element pairs may be disposed on the four remaining lattice points.

In either case, each basic unit is configured that the passive elements are disposed ahead of the powered antenna element and adjacent passive element by using the multilayer substrate.

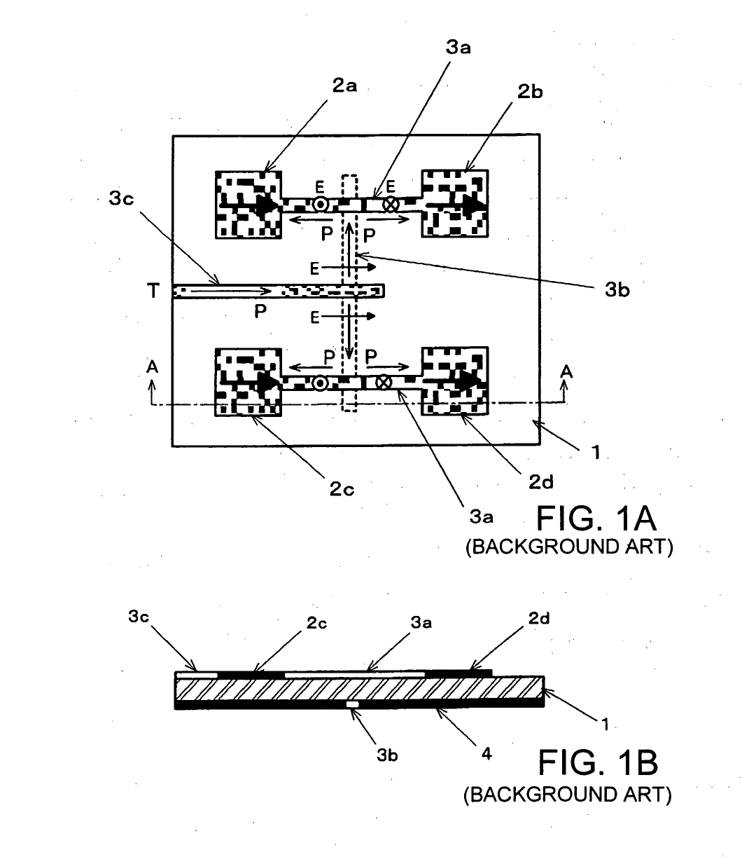

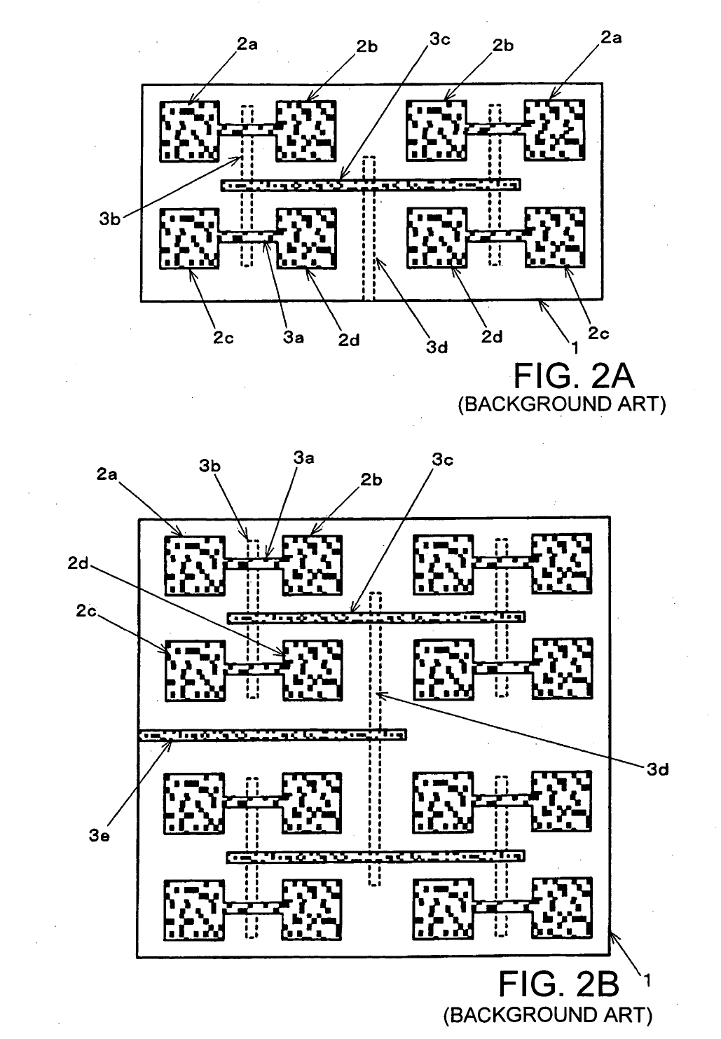

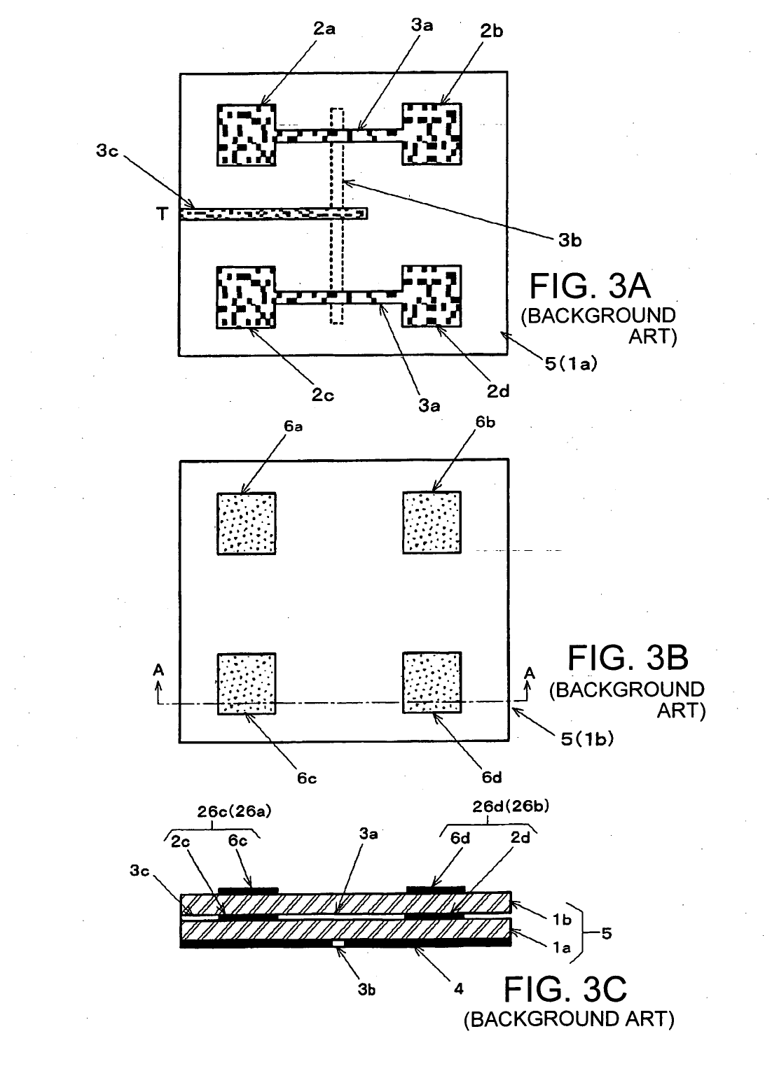

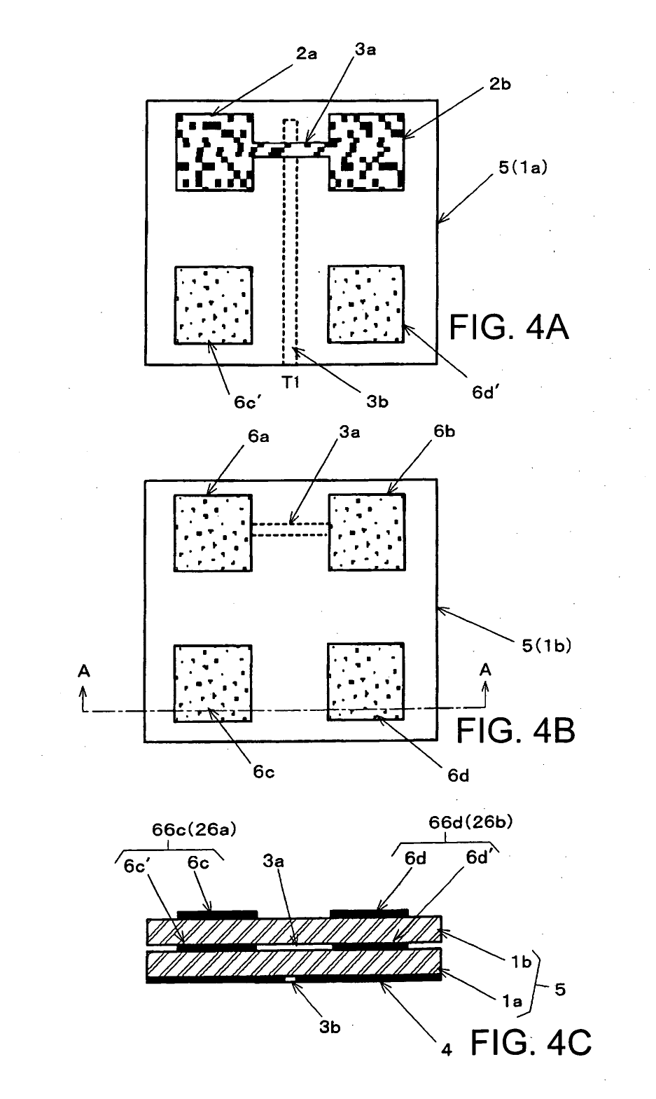

FIGS. 4A to 4C illustrate a microstrip line type planar array antenna according to the first embodiment of the present invention and show the construction of the basic unit used in this planar array antenna. It should be noted that, in FIGS. 4A to 4C, those parts which are identical to those shown in FIGS. 1A to 1C are denoted by identical reference characters and the duplicate explanations thereon are simplified.

In the basic unit shown in FIGS. 4A to 4C, first and second substrates 1a, 1b each consisted of a dielectric material are stacked and constitutes multilayer substrate 5. On the plane sandwiched by first substrate 1a and second substrate 1b, that is, an intermediate layer, two pieces of powered antenna elements 2a, 2b are arranged at the positions corresponding to the both ends of one side of a geometric square, for example, a regular square, and two pieces of adjacent passive element 6c′, 6d′ are arranged at the two remaining apexes of the regular square. In the example shown in the figures, powered antenna elements 2a, 2b are disposed on the upper side and adjacent passive elements 6c′, 6d′ are disposed on the lower side. Each of the powered antenna elements and adjacent passive elements is formed by a substantially square conductor. On the surface of second substrate 1b, passive elements 6a, 6b, 6c, 6d each consisted of a substantially square conductor are arranged at the positions just above the powered antenna elements 2a, 2b and adjacent passive elements 6c′, 6d′ so that passive elements 6a, 6b, 6c, 6d oppose to the powered antenna elements and the adjacent passive elements.

Powered elements pairs 26a, 26b are thus formed by powered antenna elements 2a, 2b in the intermediate layer and passive elements 6a, 6bon the surface, and passive element pairs 66c, 66d are formed by adjacent passive antenna elements 6c′, 6d′ in the intermediate layer and passive elements 6c, 6don the surface. Here, the distance between the element in the intermediate layer and the element on the surface in each element pair 26a, 26b66c, 66d is equal to the thickness of second substrate 1b and identical to each other.

The feeding system of such a basic unit comprises microstrip line 3a, which is a first feeding line, and slot line 3b, which is a second feeding line. Microstrip line 3a is arranged in the intermediate layer of multilayer substrate 5 and connects powered antenna elements 2a, 2b. Slot line 3b is formed in ground conductor 4 which is provided on the reverse surface of multilayer substrate 5 and extends from feeding end T1 which is provided at the lower side in the figure. The tip end of slot line 3b traverses the midpoint of microstrip line 3a. In this case, slot line 3 passes through the region between passive element pairs 66c, 66d.

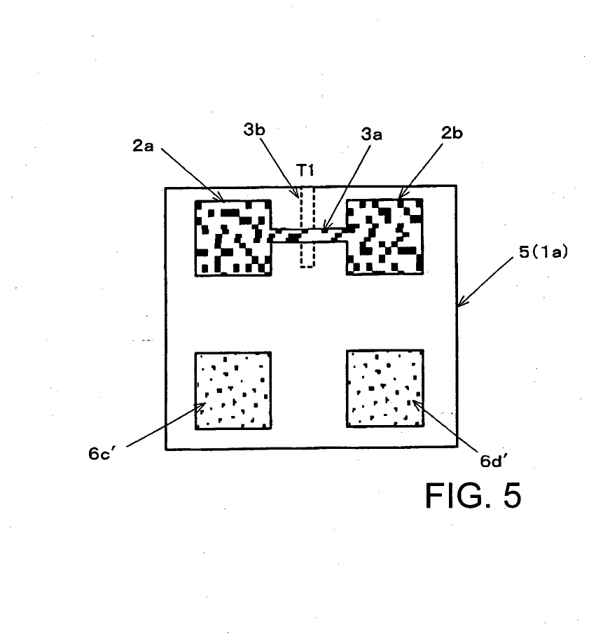

FIG. 5 illustrates a basic unit shown in FIGS. 4A to 4C in which the position of feeding end T1 locates on the upper side of the basic unit. In this case, slot line 3b does not pass through the region between passive element pairs 66c, 66d.

Since the basic unit is constructed in this way, as with the case of the conventional planar array antenna, the high frequency power traveling on slot line 3b from feeding end T1 branches in opposite phase in the left and right directions at the midpoint of microstrip line 3a, and is supplied to powered antenna elements 2a, 2b. As a result, powered antenna elements 1a, 2b are excited by the electric fields in the same direction and emit electromagnetic waves with the same polarization plane. The antenna elements operates in the same way upon receiving the electromagnetic wave.

As described above, powered element pairs 26a, 26b and passive element pairs 66c, 66d are adjacently arranged, and the interval between the powered antenna elements and the passive elements in powered element pairs 26a, 26b is equal to the interval between the adjacent passive elements and the passive elements in passive element pairs 66c, 66d. As a result, passive elements pairs 66c, 66d easily pick up the electromagnetic field leaked from powered element pairs 26a, 26b and both element pairs are easily electromagnetically coupled to each other. Since passive element pairs 66c, 66d are disposed in the magnetic field plane direction of the electromagnetic wave emitted from powered antenna elements 2a, 2b, passive element pairs 66c, 66d are directly electromagnetically coupled to powered antenna elements 2a, 2b and powered element pairs 26a, 26b. The passive element pairs are electromagnetically coupled to the powered element pairs more closely than the case in which the passive element pairs are disposed in the oblique direction of the powered element pairs.

In this way, the electromagnetic coupling between powered element pairs 26a, 26b and passive element pairs 66c, 66d is enhanced in this basic unit, and passive element pairs 66c, 66d also emit electromagnetic wave with large electromagnetic field intensity at the antenna frequency. Then the electromagnetic waves from powered element pairs 26a, 26b and passive element pairs 66a, 66b are combined and emitted. As a result, a planar array antenna having an antenna gain equivalent to that of a conventional array antenna in which all antenna elements are powered antenna elements is obtained. In this way, according to the present embodiment, it is possible to reduce the number of powered antenna elements to which high frequency power is supplied while improving the antenna gain. Specifically, since a basic unit which is a constitutional unit upon constructing an array antenna is constituted from two sets of powered element pairs 26a, 26b and two sets of passive element pairs 66c, 66d, the number of the powered antenna elements which constitutes the basic unit can be reduced by half in comparison with the conventional basic unit of a four-element type.

Further, in the present embodiment, powered antenna elements 2a, 2b are arranged in the intermediate layer of multilayer substrate 5 and passive elements 6a, 6b are arranged on the surface of multilayer substrate 5 so that the passive elements oppose to the powered antenna elements. Therefore, the distance between powered antenna elements 2a, 2b and ground conductor 4 differs from the distance between passive elements 6a, 6b and ground conductor 4. Further more, first substrate 1a and second substrate 1b each having a larger dielectric constant than the air are interposed between the powered antenna elements and passive elements, and the ground conductor. As a result, a resonant frequency based on powered antenna elements 2a, 2b in the intermediate layer and ground conductor 4 differs from a resonant frequency based on passive elements 6c, 6d on the surface and ground conductor 4, and then the frequency band based on the antenna based on powered antenna elements 2a, 2b becomes a wideband.

It should be noted that the frequency band of the antenna can be further extended by, for example, making difference between the size of powered antenna elements 2a, 2b and adjacent passive elements 6c′ 6d′ which are arranged on the intermediate layer and the size of passive elements 6a, 6b, 6c, 6d which are arranged on the surface. The bandwidth widening of the frequency band by such a technique is applicable to the second and third embodiments described below.

An array antenna which uses the same multilayer substrate 5 and has more elements can be arranged by preparing a plurality of the basic units described above and arranging the basic units in an array. For example, a four-element array antenna unit having four sets of the powered element pairs and four sets of the passive element pairs can be constructed by using two sets of the basic units, and an eight-element array antenna unit having eight sets of the powered element pairs and eight sets of the passive element pairs can be constructed by using two sets of these four-element planar array antenna units. Similarly, with n being an integer larger than or equal to 3, a 2ⁿ⁺¹-element array antenna unit can be constructed by using 2ⁿ sets of the basic units.

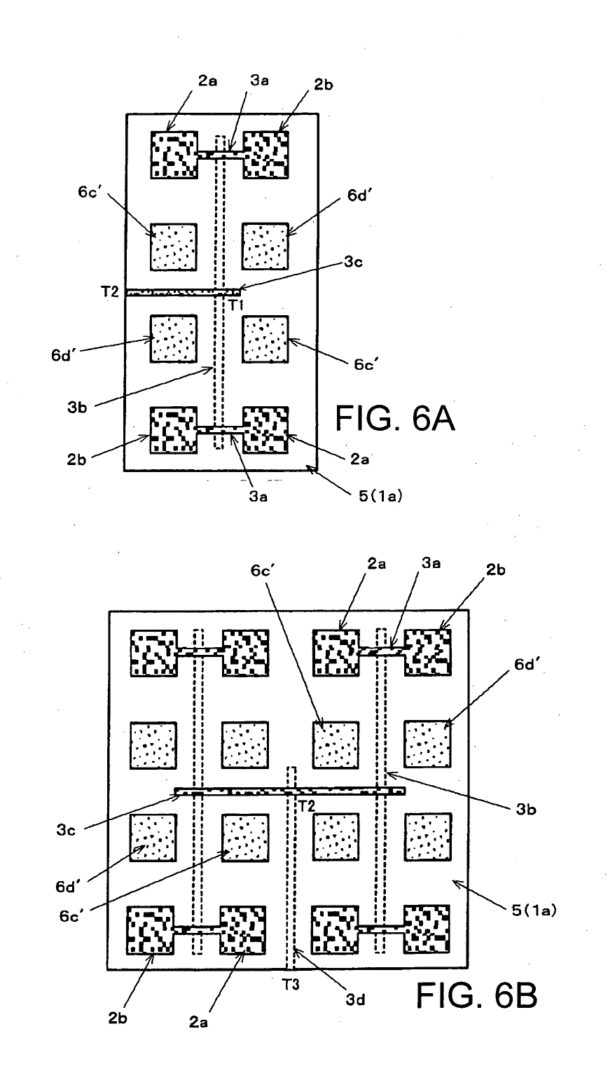

FIG. 6A illustrates a four-element array antenna unit thus constructed, especially the intermediate layer thereof. This four-element array antenna unit uses two sets of the basic units shown in FIGS. 1A to 1C. Powered antenna elements 2a, 2b and adjacent passive elements 6c′, 6d′ disposed on the intermediate layer of multilayer substrate 5, that is, on one surface of first substrate 1a, are arranged in mirror symmetry or, as shown in the figure, in point symmetry around feeding ends T1 of slot lines 3b of the basic units as a center. As a result, slot lines 3d provided on the reverse surface of multilayer substrate 5 are mutually connected between the basic units, and both ends of mutually-connected slot line 3b traverse the midpoints of microstrip lines 3a corresponding to the respective basic units. Microstrip line 3c which is a third feeding line and extended from feeding end T2 is provided in the intermediate layer of multilayer substrate 5, and the tip end of microstrip line 3c traverses the midpoint of feeding slot line 3b and is electromagnetically coupled with slot line 3b.

In this four-element array antenna, as described above, the high frequency power supplied to microstrip line 3c branches in-phase with the electric field into the upper and lower directions at the midpoint of slot line 3b. That is, the high frequency power is subjected to an in-phase branching. The high frequency power then branches in opposite phase with the electric field into the left and right directions at the midpoints of microstrip lines 3a of the upper side and lower side in the figure. That is, the high frequency power is subjected to an opposite-phase branching. Then the high frequency power is supplied to powered antenna elements 2a, 2b which connect to the both ends on microstrip lines 3a. As a result, total four pieces of powered antenna elements 2a, 2b are excited in-phase.

FIG. 6B illustrates an eight-element array antenna unit constructed by using two sets of four-element array antenna- units shown in FIG. 6A, especially the intermediate layer thereof. This eight-element array antenna unit uses four sets of the basic units shown in FIGS. 1A to 1C. Specifically, the eight-element array antenna unit is configured so that the two sets of four-element array antenna units are arranged in point symmetry around feeding points T2 of microstrip lines 3c as a center as with the above case. As a result, microstrip lines 3c provided on the intermediate layer of both four-element array antenna units are mutually connected, and both ends of mutually-connected microstrip line 3c traverse the midpoints of slot lines 3b, respectively. Further, slot line 3d which is a fourth feeding line and extended from feeding end T3 is provided in the reverse surface of multilayer substrate 5, the tip end of slot line 3d traversing the midpoint of feeding microstrip line 3c.

Similarly, an array antenna having more number of the powered antenna elements can be constructed by combining the array antenna units with the same manner. For example, with n being larger than or equal to 3, a 2ⁿ-element array antenna units includes 2ⁿ⁻¹ sets of the basic units. An (n+1)-th feeding line is connected to a feeding end of the 2ⁿ-element array antenna unit. By arranging two sets of these 2ⁿ-element array antenna units in point symmetry around the feeding point as a center, the (n+1)-th feeding lines of both 2ⁿ-element array antenna units are mutually connected and the both ends of the mutually-connected (n+1)-th feeding line traverse the midpoints of the n-th feeding lines, respectively, and are electromagnetically coupled with the n-th feeding lines. Then, an (n+2)-th feeding line which traverses the midpoint of the (n+1)-th feeding line and electromagnetically couples thereto is provided with one end of the (n+2)-th feeding line being connected to a feeding end. By incrementing n in this way, a planar array antenna having the increased number of the powered antenna elements which uses the same multilayer substrate 5 can be constructed. It should be noted that the (n+2)-th feeding line is a microstrip line when n is an odd number, and the (n+2)-th feeding line is a slot line when n is an even number.

Also in the multi-element array antenna unit thus constructed, passive elements 6a, 6b, 6c, 6d are arranged on the surface of multilayer substrate 5 at the respective positions corresponding powered antenna elements 2a, 2b and adjacent passive elements 6c′, 6d′ in the intermediate layer so that powered element pairs 26a, 26b and passive element pairs 66c, 66d are formed. The above advantages of the basic unit having powered element pairs 26a, 26b and passive element pairs 66c, 66d are exerted in this multi-element array antenna unit. As a result, the antenna gain can be improved and the number of powered antenna elements can be reduced.

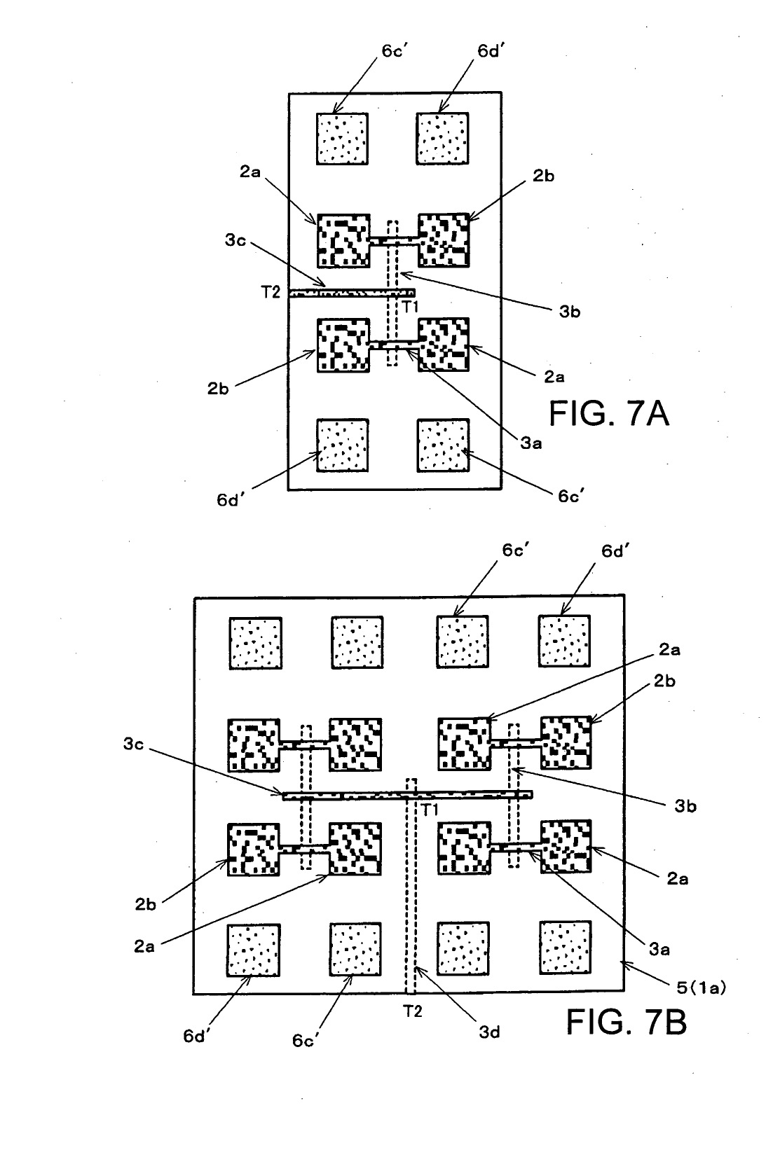

It should be noted that a multi-element array antenna unit can be constructed in the same manner as described above by using basic units having the arrangement shown in FIG. 5. FIG. 7A illustrates a four-element array antenna unit constructed by using the basic units shown in FIG. 5, especially the intermediate layer thereof. FIG. 7B illustrates an eight-element array antenna unit constructed by using the basic units shown in FIG. 5, especially the intermediate layer thereof.

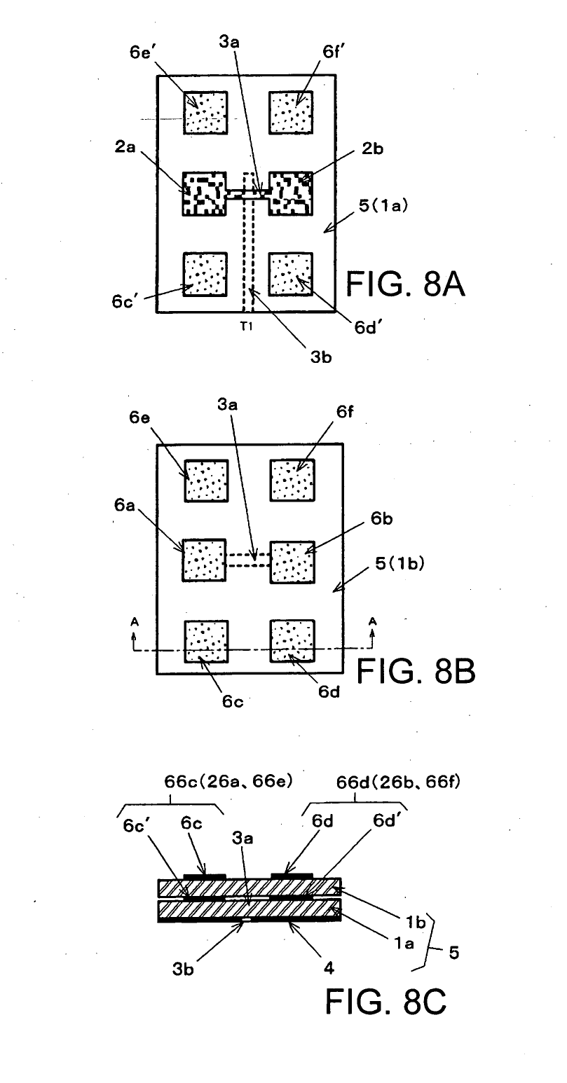

FIGS. 8A to 8C illustrate a microstrip line type planar array antenna according to the second embodiment of the present invention and show the construction of the basic unit used in this planar array antenna. It should be noted that, in FIGS. 8A to 8C, those parts which are identical to those shown in FIGS. 4A to 4C are denoted by identical reference characters and the duplicate explanations thereon are simplified.

Also with the second embodiment, in the basic unit, first and second substrates 1a, 1b each consisted of a dielectric material are stacked and constitute multilayer substrate 5. Ground conductor 4 is provided on the reverse surface of multilayer substrate 5. On the plane sandwiched by first substrate 1a and second substrate 1b, that is, an intermediate layer, powered antenna elements 2a, 2b are arranged at the positions corresponding to the midpoints of the longer sides of a rectangle, respectively, and adjacent passive elements 6c′, 6d′, 6e′, 6f′ are arranged at the positions corresponding to the four apexes of the rectangle. In other words, among the lattice points arranged in 2×3 in an orthogonal grid, powered antenna elements 2a, 2b are arranged on the two central lattice points and adjacent passive elements 6c′, 6d′, 6e′, 6f′ are arranged on the four remaining lattice points. Passive elements 6a, 6b, 6c, 6d, 6e, 6f are disposed on the surface of multilayer substrate 5 so that passive elements 6a, 6b, 6c, 6d, 6e, 6f oppose to powered antenna elements 2a, 2b and adjacent passive elements 6c′, 6d′, 6e′, 6f′, respectively. As with the above case, powered antenna elements 2a, 2b and passive elements 6a, 6b constitute powered element pairs 26a, 26b, and adjacent passive elements 6c′, 6d′, 6e′, 6f′ and passive elements 6c, 6d, 6e, 6f constitute passive element pairs 66c, 66d, 66e, 66f.

Powered antenna elements 2a, 2b are connected by microstrip line 3a provided in the intermediate layer and fed with the high frequency power through a feeding system having the similar configuration as with the case of the first embodiment.

In such a configuration, passive element pairs 66c, 66d, 66e, 66f are disposed adjacent to powered element pairs 26a, 26b as with the case of the first embodiment, passive element pairs 66c, 66d, 66e, 66f easily pick up the leak electromagnetic field from powered element pairs 26a, 26b, and the powered element pairs and the passive element pairs are electromagnetically coupled to each other easily. Passive element pairs 66c, 66d, 66e, 66f are arranged on both sides in the direction of the magnetic field plane emitted from powered antenna elements 2a, 2b, and directly electromagnetically coupled to powered antenna elements 2a, 2b and powered element pairs 26a, 26b.

In this way, the electromagnetic coupling between powered element pairs 26a, 26b and passive element pairs 66c, 66d, 66e, 66f are enhanced in this basic unit, and passive element pairs 66c, 66d, 66e, 66f also emit electromagnetic wave with large electromagnetic field intensity at the antenna frequency. Then the electromagnetic waves from powered element pairs 26a, 26b and passive element pairs 66a, 66b, 66e, 66f are combined and emitted. As a result, a planar array antenna having an antenna gain equivalent to that of a conventional array antenna in which all antenna elements are powered antenna elements is obtained. In this way, according to the present embodiment, it is possible to reduce the number of the powered antenna elements to which high frequency power is supplied while improving the antenna gain. Specifically, since a basic unit which is a constitutional unit upon constructing an array antenna is constituted from two sets of powered element pairs 26a, 26b and four sets of passive element pairs 66c, 66d, 66e, 66f, the number of the powered antenna elements which constitutes the basic unit can be reduced by half in comparison with the conventional basic unit of a four-element type.

It should be noted that, in the present embodiment, since the passive element pairs are arranged on both sides of the magnetic field plane direction of the electromagnetic wave emitted from the powered antenna element, the intensity of the emitted electromagnetic wave is enhanced in comparison with the case of the first embodiment.

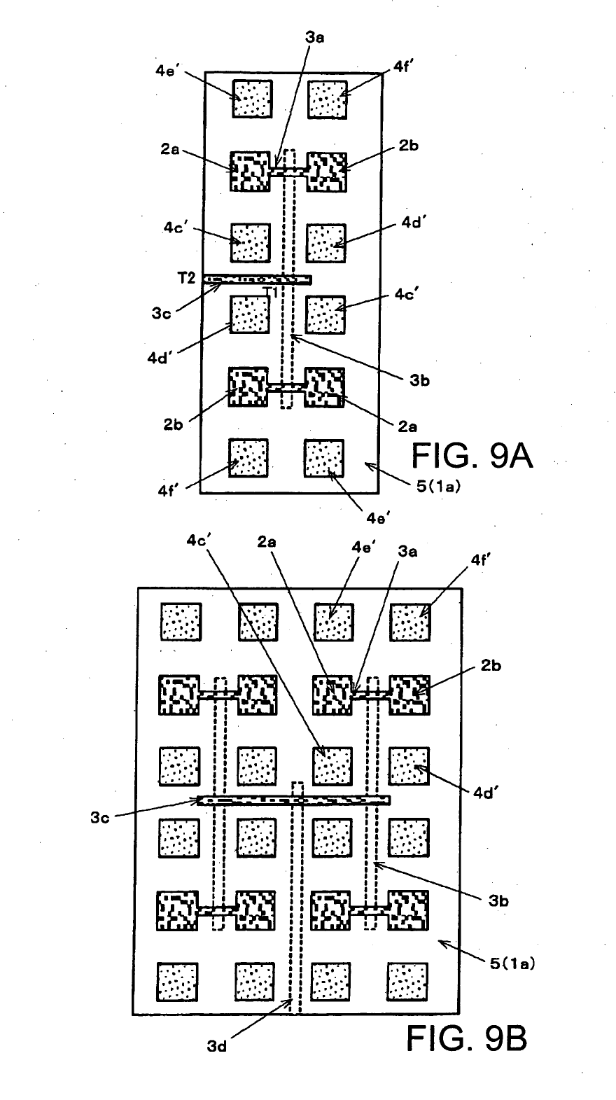

Also in the second embodiment, an array antenna which uses the same multilayer substrate 5 and has more elements can be arranged by preparing a plurality of the basic units described above and arranging the basic units in an array. For example, a four-element array antenna unit having four sets of the powered element pairs and four sets of the passive element pairs can be constructed by using two sets of the basic units and arranging the basic units in point symmetry around feeding end T1 as a center, and an eight-element array antenna unit having eight sets of the powered element pairs and eight sets of the passive element pairs can be constructed by using two sets of this four-element planar array antenna units. Similarly, with n being an integer larger than or equal to 3, a 2ⁿ⁺¹-element array antenna unit can be constructed by using 2ⁿ sets of the basic units. FIG. 9A illustrates a four-element array antenna unit constructed as described above, especially the intermediate layer thereof, and FIG. 9B illustrates an eight-element array antenna unit, especially the intermediate layer thereof. Since array antenna units shown in FIGS., 9A and 9B can be constructed in the same manner as the array antenna units shown in FIGS. 6A and 6B, the duplicate explanation is not repeated here.

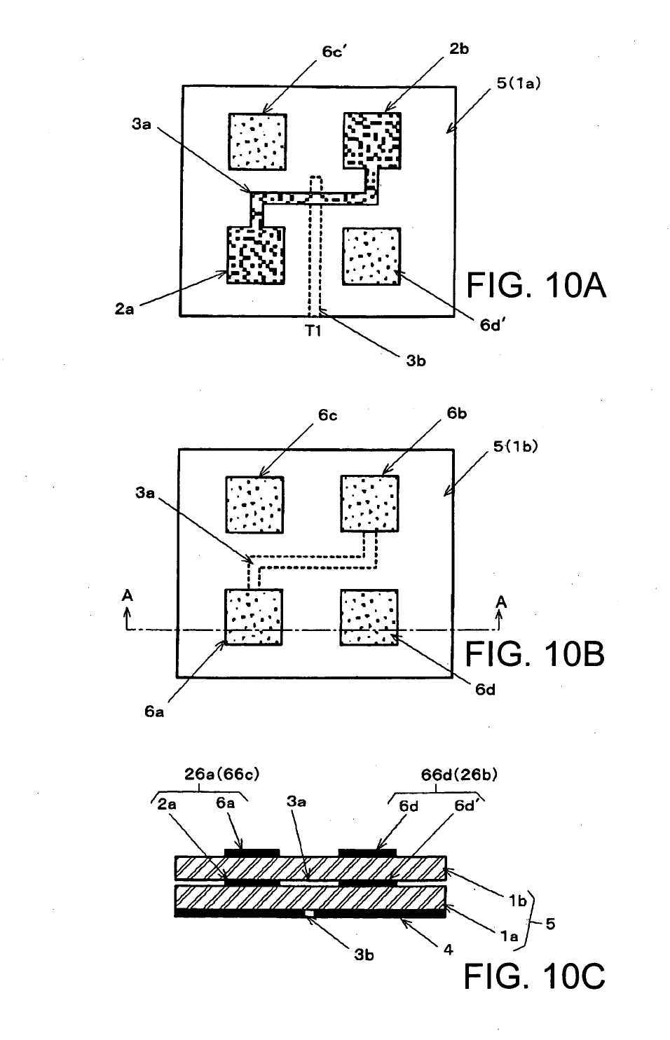

FIGS. 10A to 10C illustrate a microstrip line type planar array antenna according to the third embodiment of the present invention and show the construction of the basic unit used in this planar array antenna. It should be noted that, in FIGS. 10A to 10C, those parts which are identical to those shown in FIGS. 4A to 4C are denoted by identical reference characters and the duplicate explanations thereon are simplified.

Also with the third embodiment, in the basic unit, first and second substrates 1a, 1b each consisted of a dielectric material are stacked and constitute multilayer substrate 5. Ground conductor 4 is provided on the reverse surface of multilayer substrate 5. On the plane sandwiched by first substrate 1a and second substrate 1b, that is, an intermediate layer, powered antenna elements 2a, 2b are arranged at the positions corresponding to both ends of a diagonal of a regular square or a rectangle, respectively, and adjacent passive elements 6c′, 6d′ are arranged at the positions corresponding to both ends of the other diagonal. Passive elements 6a, 6b, 6c, 6d are disposed on the surface of multilayer substrate 5 so that passive elements 6a, 6b, 6c, 6d oppose to powered antenna elements 2a, 2b and adjacent passive elements 6c′, 6d′, respectively. As with the above case, powered antenna elements 2a, 2b and passive elements 6a, 6b constitute powered element pairs 26a, 26b, and adjacent passive elements 6c′, 6d′ and passive elements 6c, 6d, constitute passive element pairs 66c, 66d.

Powered antenna elements are connected through microstrip line 3a formed in a crank shape in the intermediate layer 5 of multilayer substrate 5 and fed with the high frequency power through a feeding system having the similar configuration as with the case of the first embodiment.

In such a configuration, passive element pairs 66c, 66d are disposed adjacent to powered element pairs 26a, 26b as with the case of the first and second embodiments, passive element pairs 66c, 66d easily pick up the leak electromagnetic field from powered element pairs 26a, 26b, and the powered element pairs and the passive element pairs are electromagnetically coupled to each other easily. Passive element pairs 66c, 66d are arranged in both of the electric field plane direction and magnetic field plane direction of the electromagnetic wave emitted from powered antenna elements 2a, 2b, and directly electromagnetically coupled to powered antenna elements 2a, 2b and powered element pairs 26a, 26b. In this case, since the passive element pairs are directly electromagnetically coupled to the powered element pairs in both of the horizontal direction and vertical direction in the figure, the degree of coupling between the powered element pairs and the passive element pairs is further enhanced in comparison with the cases of the above first and second embodiments.

In this way, the electromagnetic coupling between powered element pairs 26a, 26b and passive element pairs 66c, 66d is enhanced in this basic unit, and passive element pairs 66c, 66d also emit electromagnetic wave with large electromagnetic field intensity at the antenna frequency. Then the electromagnetic waves from powered element pairs 26a, 26b and passive element pairs 66a, 66b are combined and emitted. As a result, a planar array antenna having an antenna gain equivalent to that of a conventional array antenna in which all antenna elements are powered antenna elements is obtained. In this way, according to the present embodiment, it is possible to reduce the number of the powered antenna elements to which high frequency power is supplied while improving the antenna gain. Specifically, since a basic unit which is a constitutional unit upon constructing an array antenna is constituted from two sets of powered element pairs 26a, 26b and two sets of passive element pairs 66c, 66d , the number of the powered antenna elements which constitutes the basic unit can be reduced by half in comparison with the conventional basic unit of a four-element type.

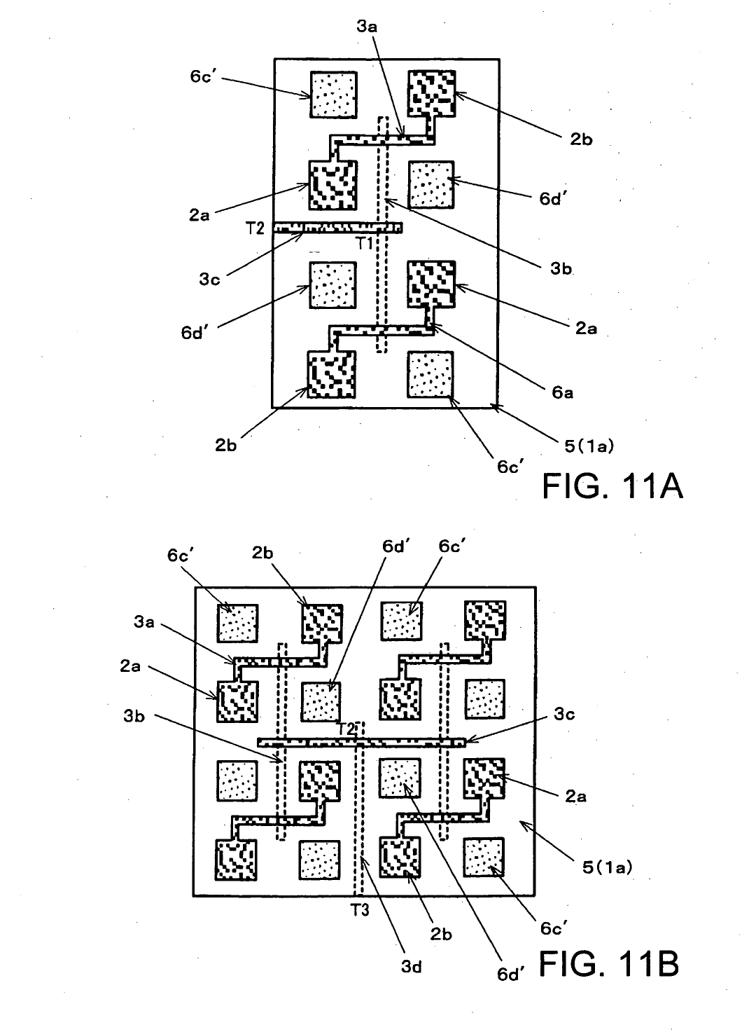

Also in the third embodiment, an array antenna which uses the same multilayer substrate 5 and has more elements can be arranged by preparing a plurality of the basic units described above and arranging the basic units in an array. For example, a four-element array antenna unit having four sets of the powered element pairs and four sets of the passive element pairs can be constructed by using two sets of the basic units and arranging the basic units in point symmetry around feeding end T1 as a center, and an eight-element array antenna unit having eight sets of the powered element pairs and eight sets of the passive element pairs can be constructed by using two sets of these four-element planar array antenna units. Similarly, with n being an integer larger than or equal to 3, a 2ⁿ⁺¹-element array antenna unit can be constructed by using 2ⁿ sets of the basic units. FIG. 11A illustrates a four-element array antenna unit constructed as described above, especially the intermediate layer thereof, and FIG. 11B illustrates an eight-element array antenna unit, especially the intermediate layer thereof. Since array antenna units shown in FIGS. 11A and 11B can be constructed in the same manner as the array antenna units shown in FIGS. 6A and 6B, the duplicate explanation is not repeated here.

It should be noted that, in the case of the basic unit according to the third embodiment shown in FIGS. 10A to 10C, two powered element 2a, 2b disposed in an oblique direction are mutually connected by microstrip line 3a, which is the first feeding line, in the intermediate layer of multilayer substrate 5. In this case, microstrip line is not straight but has folded portions and the folded portions are located near powered antenna elements 2a, 2b. Electromagnetic wave of a cross-polarization is emitted from the folded portion of microstrip line 3a, and the cross-polarization component functions as a noise component to, for example, the electromagnetic wave component of vertical polarization which is emitted from each of powered antenna elements 2a, 2b by the feeding from the vertical direction.

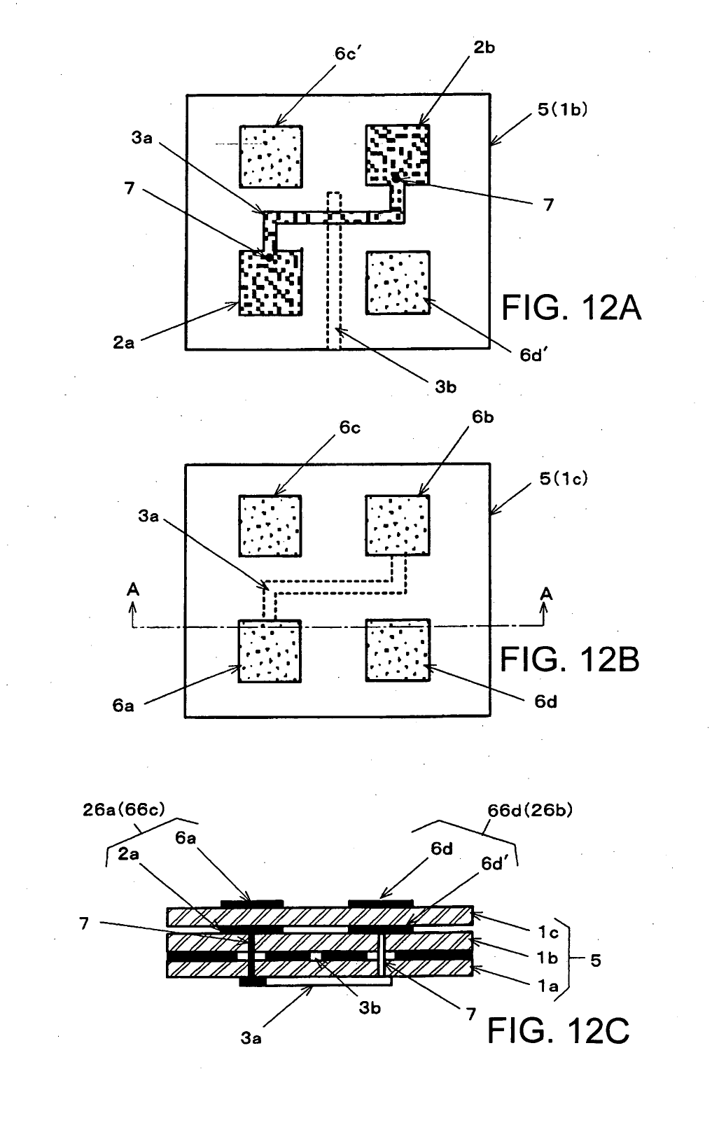

A basic unit in which emission of the cross-polarization component is suppressed is shown in FIGS. 12A to 12C. In the basic unit shown in FIGS. 12A to 12C, multilayer substrate 5 is constructed by stacking first substrate 1a, second substrate 1b and third substrate 1c. With the joining plane between first substrate 1a and second substrate 1b taken as a first intermediate layer and the joining plane between second substrate 1b and third substrate 1c taken as a second intermediate layer, powered antenna elements 2a, 2b and adjacent passive elements 6c′, 6d′ are arranged in the second intermediate layer, and passive elements 6a, 6b, 6c, 6d are arranged on the surface of multilayer substrate 5, that is, the surface of third substrate 1c. Ground conductor 4 in which slot line 3b as a second feeding line is arranged is disposed in the first intermediate layer. Microstrip line 3a formed in a crank shape, which is a first feeding line, is disposed on the reverse surface of multilayer substrate 5. Microstrip line 3a and powered antenna elements 2a, 2b are connected through via-holes 7. In this configuration, the electromagnetic wave emitted from the folded portion of microstrip line 3a is blocked by ground conductor 4 arranged in the first intermediate layer. Powered antenna elements 2a, 2b can be fed with the high frequency power in only the vertical direction from the vertically extending portion in the figure of microstrip line 3a. Consequently, the vertical polarization in which the noise component due to the cross-polarization component is suppressed can be radiated by using this basic unit.

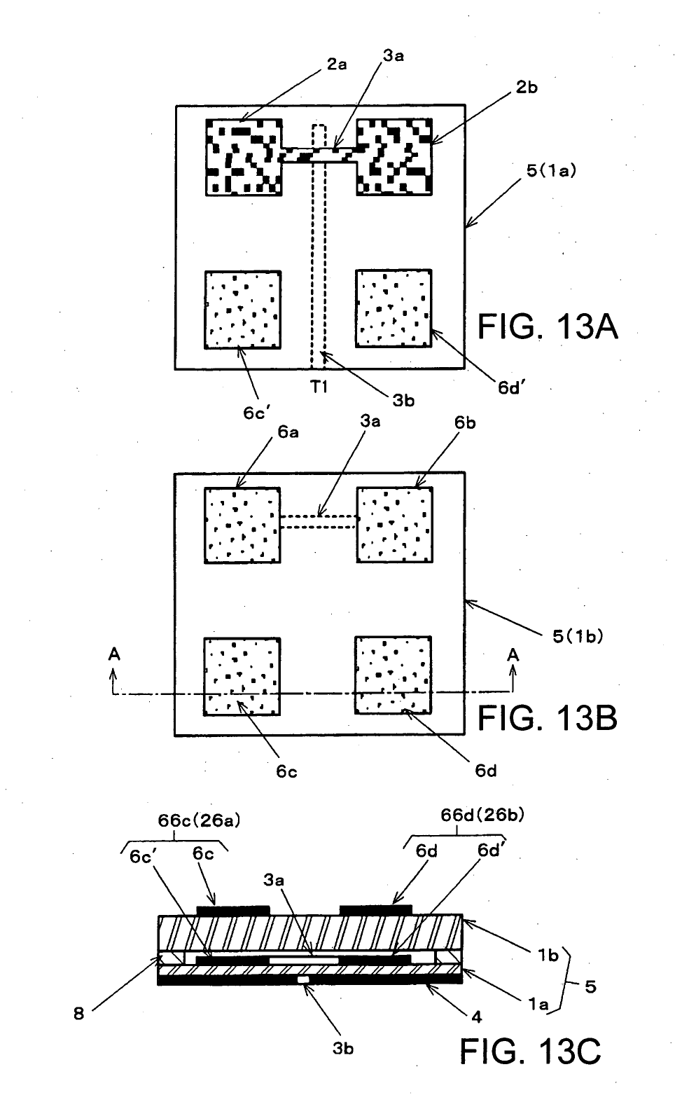

While first substrate 1a and second substrate 1b are stacked to form multilayer substrate 5 in the above-described embodiments, a configuration in which a hollow portion is arranged within multilayer substrate 5 is possible. A basic unit shown in FIGS. 13A to 13C is one similar to that shown in FIGS. 4A to 4C, but is configured that a spacing is formed between first substrate 1A and second substrate 1B by interposing spacer 8 so that a hollow portion is formed at the position of the intermediate layer. In this case, powered antenna elements 2a, 2b and adjacent passive elements 6c′, 6d′ are formed on the principal surface of first substrate 1a. Passive elements 6a, 6b, 6c, 6d are formed on the outer surface of second substrate 1b. In this case, with the wavelength corresponding to the antenna frequency taken as λ, distance from powered antenna elements 2a, 2b and adjacent passive elements 6c′, 6d′ to passive elements 6a, 6b, 6c, 6d is set to a length of approximately λ/2.

In this configuration, in this case, in addition to the first resonant frequency determined from the distance between powered antenna elements 2a, 2b and passive elements 6a, 6d, a second resonant frequency which is determined by the distance from powered antenna elements 2a, 2b to the inner surface of second substrate 1b, that is, the surface oriented to the hollow portion appears. Therefore, for example, it is possible to extend the frequency band of the antenna by using the second resonant frequency as well as it is possible to increase the antenna gain by setting the first resonant frequency to the antenna frequency.

While the powered antenna elements, adjacent passive elements, and passive elements have been described as being regular square in shape, the shape may be rectangular, and further, it may be circular including an elliptical shape. One can select the shape of these elements according to the requirement. The configuration of the planar array antenna such as the mutual distance between powered antenna elements 2a, 2b, and the distance between the basic units in the case of constructing a multi-element array antenna unit may be arbitrarily determined based on specification according to the directivity characteristic, band width, antenna gain, application of the antenna, or the like.

1. A planar array antenna comprising:
a substrate made of a dielectric material;
a powered antenna element of a microstrip-line type disposed on one principal surface of said substrate;
a ground conductor disposed on the other principal surface of said substrate;
a feeding system for feeding high frequency power to the powered antenna element;
an adjacent passive element disposed on the one principal surface of said substrate;
a first passive element disposed ahead of said powered antenna element with space therebetween; and
a second passive element disposed ahead of said adjacent passive element with space therebetween;
wherein said powered antenna element and a first passive element corresponding to the powered antenna element constitute a powered element pair,
said adjacent passive element and a second passive element corresponding to the adjacent passive element constitute a passive element pair, and
said passive element pair is disposed so that it adjoins said powered element pair in an electric field direction or a magnetic field direction of radio wave emitted from said powered antenna element.

2. The planar array antenna according to claim 1, wherein a spacing between said powered antenna element and said first passive element is identical to a spacing between said adjacent passive element and said second passive element.

3. The planar array antenna according to claim 2, wherein said first passive element and said second passive element are disposed on a surface of a second substrate which is arranged on said one principal surface.

4. The planar array antenna according to claim 2, wherein
two sets of said powered element pairs and a plurality of sets of said passive element pairs constitute a basic unit;
said feeding system comprises a first feeding line consisting of a microstrip-line which connects at both ends thereof to two powered antenna elements in the same basic unit, and a second feeding line consisting of a slot line formed in said ground conductor, said second feeding line traversing a midpoint of said first feeding line and electromagnetically coupled to said first feeding line.

5. The planar array antenna according to claim 4, comprising a plurality of pieces of said basic units, wherein said feeding system is constructed by combining an opposite-phase branching to a microstrip line from a slot line and an in-phase branching to a slot lint from a microstrip line, and the powered antenna elements of each of the basic units is fed from a single feeding end.

6. The planar array antenna according to claim 4, constructed as a four-element array antenna unit, comprising:
two pieces of said basic units, said two pieces of the basic units being arranged in point symmetry or mirror symmetry around a feeding end of said second feeding line as a center; said second feeding line of each of said basic units being connected in common; and
a third feeding line consisting of a microstrip line, which traverses a midpoint of the common-connected second feeding line and is electromagnetically coupled to the common-connected second feeding line.

7. A planar array antenna which uses the four-element array antenna unit according to claim 6 as a base and is constructed as 2ⁿ⁺¹-element array antenna unit, comprising:
two pieces of 2ⁿ-array antenna units where n is an integer greater than or equal to 2, said two pieces of the 2ⁿ-array antenna units being arranged in point symmetry or mirror symmetry around a feeding end of the (n+1)-th feeding line as a center; said (n+1)-th feeding line of each of said 2ⁿ-array antenna units being connected in common; and
an (n+2)-th feeding line which traverses a midpoint of the common-connected (n+1)-th feeding line and is electromagnetically coupled to the common-connected (n+1)-th feeding line,
wherein, n being an integer, if n is an odd number the (n+2)-th feeding line is a microstrip line, and if n is an even number the (n+2)-th feeding line is a slot line.

8. The planar array antenna according to claim 4, wherein said basic unit comprises two sets of said passive element pairs,
in said basic unit, the powered element pairs are disposed on positions corresponding to both ends of one side of a regular square or rectangle, said passive element pairs are disposed on positions corresponding to both ends of a side which opposes to said one side.

9. The planar array antenna according to claim 4, wherein said basic unit comprises four sets of said passive element pairs,
in said basic unit, the powered element pairs are disposed on positions corresponding to midpoints of longer sides of a rectangle, said passive element pairs are disposed on positions corresponding to apexes of said rectangle.

10. The planar array antenna according to claim 4, wherein said basic unit comprises two sets of said passive element pairs,
in said basic unit, the powered element pairs are disposed on positions corresponding to both ends of one diagonal of a regular square or rectangle, said passive element pairs are disposed on positions corresponding to both ends of the other diagonal.

11. The planar array antenna according to claim 10, comprising an auxiliary substrate which is formed on said ground conductor and consists of a dielectric material, wherein said first feeding line is formed as a cranked microstrip line on said auxiliary substrate, and both ends of said first feeding line are connected to said powered antenna elements through via-holes, respectively.

12. The planar array antenna according to claim 4, wherein said first passive element and said second passive element are disposed on a surface of a second substrate which is laminated on said one principal surface.

13. The planar array antenna according to claim 4, wherein said first passive element and said second passive element are disposed on an outer surface of a second substrate which is disposed on said one principal surface via a hollow portion.

14. The planar array antenna according to claim 5, wherein said plurality of basic units share said first substrate and said second substrate.
